(19) United States
(12) Patent Application Publication
(10) Pub. No.: US 2026/0243500 A1
(43) Pub. Date: Aug. 20, 2026

(54) GASKET FOR REFRIGERATOR DOOR

(71) Applicant: SAMSUNG ELECTRONICS CO., LTD., Suwon-si (KR)

(72) Inventor: Mingyu JUNG, Suwon-si (KR)

(73) Assignee: SAMSUNG ELECTRONICS CO., LTD., Suwon-si (KR)

(21) Appl. No.: 19/644,695

(22) Filed: Apr. 10, 2026

Related U.S. Application Data
(63) Continuation of application No. PCT/KR2024/013367, filed on Sep. 5, 2024.

(30) Foreign Application Priority Data
Oct. 27, 2023 (KR) 10-2023-0146086

(51) Int. Cl. F25D 23/08

(52) U.S. Cl. CPC F25D 23/087

(57) ABSTRACT

A gasket for a refrigerator door with improved thermal insulation; and a refrigerator including same. The gasket for a refrigerator door includes30-60 wt % of a thermoplastic resin, 15-30 wt % of a low molecular weight plasticizer having a weight-average molecular weight of less than 500, 5-20 wt % of a high molecular weight plasticizer having a weight-average molecular weight of 500 or more, and 1-30 wt % of a filler.

### CROSS-REFERENCE TO RELATED APPLICATION

This application is a continuation application, under 35 U.S.C. § 111 (a), of international application No. PCT/KR2024/013367, filed Sep. 5, 2024, which claims priority under 35 U. S. C. § 119 to Korean Patent Application No. 10-2023-0146086, filed Oct. 27, 2023, the disclosures of which are incorporated herein by reference in their entireties.

### TECHNICAL FIELD

The disclosure relates to a gasket for a refrigerator door with improved thermal insulation.

### BACKGROUND ART

A refrigerator is an apparatus that stores food fresh by including a main body with a storage compartment and a cold air supply system that supplies cold air to the storage compartment. The storage compartment includes a refrigerating compartment maintained at approximately 0 to 5° C. to keep food refrigerated, and a freezing compartment maintained at approximately 0 to −30° C. to keep food frozen. Generally, the storage compartment is provided with a front side that is openable for food loading and unloading, and the open front side of the storage compartment is opened and closed by a door.

The refrigerator maintains the inside of the storage compartment at a low temperature through the following operation process. First, refrigerant gas is drawn into and compressed by a compressor. The compressed refrigerant gas, whose temperature has increased, is cooled and liquefied while passing through a condenser. The liquefied refrigerant is sprayed into an evaporator and vaporized, thereby absorbing heat from the inside of the storage compartment as heat of vaporization to cool the storage compartment. The vaporized refrigerant gas is drawn back into the compressor, and the inside of the storage compartment is cooled through the above-described series of processes.

When the temperature inside the refrigerator storage compartment rises, the storage compartment is maintained at a low temperature through operation of the compressor and the condenser as described above. The operating rate of the compressor and the condenser is directly related to the power consumption of the refrigerator, and in order to reduce the power consumption of the refrigerator, it is important to minimize the temperature rise inside the storage compartment so as to lower the operating rate of the compressor and the condenser.

Attached FIG. 3 is a drawing illustrating factors causing a temperature rise inside the refrigerator storage compartment and energy loss ratios of the refrigerator that are required to maintain the storage compartment at a low temperature for each factor. Referring to FIG. 3, energy loss related to thermal insulation of a refrigerator wall accounts for 52%, energy loss related to a door gasket and surrounding plastic component areas accounts for 30%, energy loss related to a defrost heater accounts for 6%, energy loss accounts for a fan motor accounts for 6%, and energy loss related to an external heater accounts for 6%. Therefore, it is required to increase the thermal insulation for the door gasket, which accounts for a relatively large portion of energy loss.

### DISCLOSURE

### Technical Problem

One aspect of the disclosure provides a gasket for a refrigerator door with improved thermal insulation.

The technical objectives of the present disclosure are not limited to the above, and other objectives that are not described above will be clearly understood by those skilled in the art from the above detailed description.

### Technical Solution

According to an aspect of the present invention, there is provided a gasket for a refrigerator door including, a thermoplastic resin in an amount of 30% to 60% in weight %; a low molecular weight plasticizer having a weight-average molecular weight of less than 500 in an amount of 15% to 30%; a high molecular weight plasticizer having a weight-average molecular weight of 500 or more in an amount of 5% to 20%; and a filler in an amount of 1% to 30%.

According to an aspect of the present invention, there is provided a gasket for a refrigerator door including: a body disposed between a refrigerator main body and the refrigerator door; and a magnet inserted into the body and configured to be attachable to and detachable from the refrigerator main body, wherein the body includes a thermoplastic resin in an amount of 30% to 60% in weight %; a low molecular weight plasticizer having a weight-average molecular weight of less than 500 in an amount of 15% to 30%; a high molecular weight plasticizer having a weight-average molecular weight of 500 or more in an amount of 5% to 20%; and a filler in an amount of 1% to 30%, and the magnet include, in weight %, ferrite powder in an amount of 40% to 89.5%, a thermoplastic resin in an amount of 10% to 40%, and a filler in an amount of 0.5% to 20%.

### Advantageous Effects

According to the concept of the disclosure, a refrigerator door gasket with improved thermal insulation performance can be provided.

Further, according to the concept of the disclosure, a refrigerator door gasket including a gasket body and a magnet, which have excellent thermal insulation performance while having mechanical properties suitable for a refrigerator door, can be provided

The effects of the present disclosure are not limited to those described above, and other effects that are not described above will be clearly understood by those skilled in the art from the above detailed description and drawings.

### DESCRIPTION OF DRAWINGS

FIG. 1 is a photograph of a refrigerator gasket body according to an embodiment of the disclosure.

FIG. 2 is a diagram illustrating heat flow in a refrigerator.

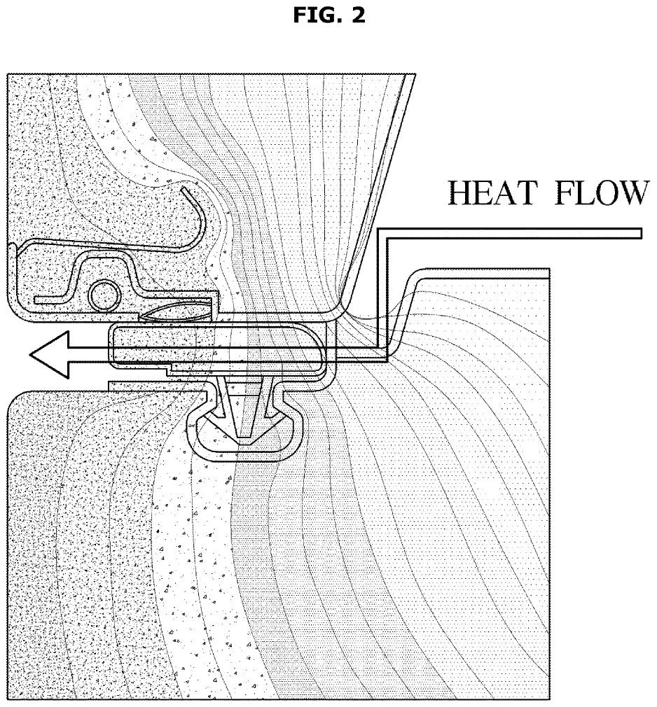

FIG. 3 is a diagram illustrating factors causing a temperature rise inside a refrigerator storage compartment and energy loss ratios of the refrigerator that are required to maintain the storage compartment at a low temperature for each factor.

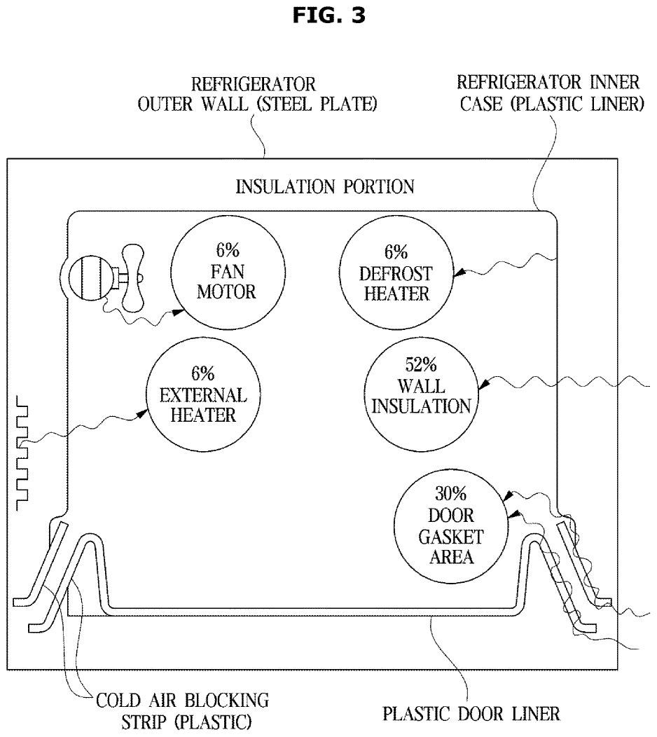

FIG. 4 is a perspective view of an open refrigerator.

FIG. 5 is a graph illustrating migration resistance according to a content of high molecular weight plasticizer.

FIG. 6 is a photograph taken with a scanning electron microscope (SEM) of a surface of a gasket body depending on whether a surface modifier is added.

### MODES OF THE DISCLOSURE

Hereinafter, preferred embodiments of the disclosure will be described. However, the embodiments of the disclosure may be modified into various other forms, and the technical spirit of the disclosure is not limited to the embodiments described below. In addition, the embodiments of the disclosure are provided to more fully explain the disclosure to those having ordinary skill in the art.

The terminology used herein is for the purpose of describing particular examples only and is not intended to be limiting. For example, singular forms include plural forms unless the context clearly indicates otherwise. In addition, it should be noted that the terms ‘include,’ ‘comprise,’ or ‘have,’ when used herein, specify the presence of stated features, steps, functions, elements, components, or combinations thereof, but do not preclude the presence or addition of one or more other features, steps, functions, elements, components, or combinations thereof.

Unless otherwise defined, all terms used herein have the same meaning as commonly understood by those having ordinary skill in the art to which the disclosure pertains. Accordingly, unless explicitly defined in this specification, terms should not be interpreted in an overly idealized or formal sense. For example, singular forms used herein include plural forms unless the context clearly dictates otherwise.

In addition, terms such as ‘approximately,’ ‘substantially,’ or the like, as used herein, are intended to have meanings close to or at the stated values when manufacturing and material tolerances inherent to the stated meanings are taken into consideration, and are used to prevent an unscrupulous infringer from unfairly exploiting the disclosure in which exact or absolute numerical values are stated to aid understanding of the disclosure

First, a structure of a gasket according to an embodiment of the disclosure and an operating principle thereof according to door opening and closing will be described with reference to the accompanying drawings. It should be noted that the gasket structure and reference numbers in the accompanying drawings are merely described to aid understanding of the disclosure and do not particularly limit the technical concept of the disclosure.

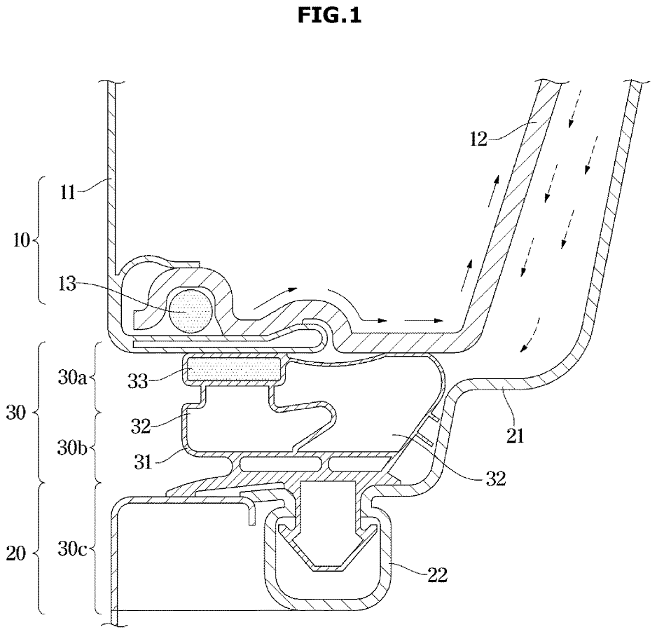

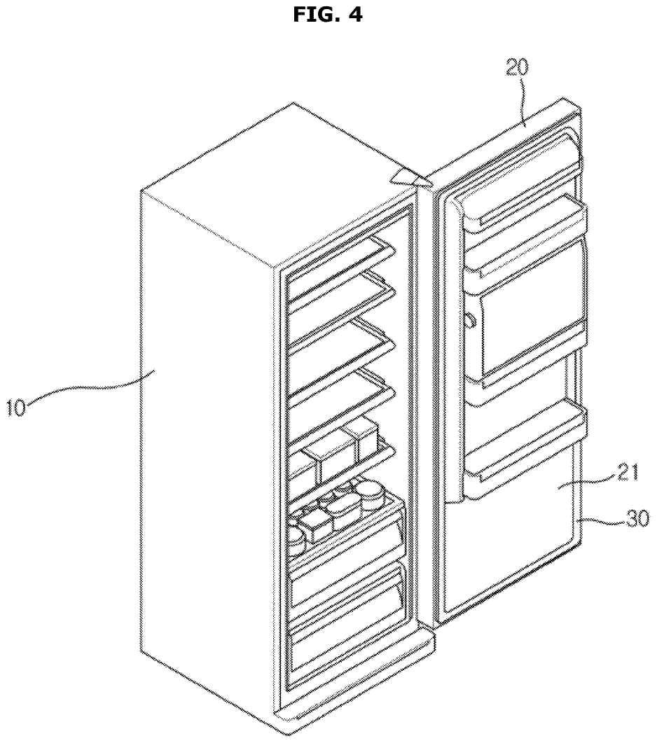

As shown in FIG. 4, a gasket 30 is disposed between a door 20 and a main body 10 of a refrigerator to prevent cold air supplied to a storage compartment from leaking to the outside. Referring to FIG. 1, the gasket 30 includes a contact portion 30a configured to be closely attached to a front surface of the main body 10 of the refrigerator by magnetic force of a magnet 33 inserted in a body 31 such that the refrigerator door 20 seals the refrigerator itself, a connection portion 30b integrally formed with a lower end of the contact portion 30a and divided by a partition wall to form a certain space at the lower end of the contact portion 30a, and an anchor-shaped coupling portion 30c integrally formed with a lower end of the connection portion 30b and inserted and fixed into a coupling groove 22 of a door liner 21 such that the contact portion 30a and the connection portion 30b may be fixed to the door liner 21 of the refrigerator door 20. An air pocket 32 defined by the partition wall in the connection portion 30b serves to absorb shock when the refrigerator door contacts the refrigerator main body.

When the refrigerator door 20 to which the gasket 30 is mounted and fixed is closed against the front surface of the refrigerator main body 10 to seal the refrigerator main body 10, the magnet 33 inserted in the contact portion 30a of the gasket 30 is attached to an outer case 11 formed of magnetic material outside the refrigerator, thereby completely isolating the interior of the refrigerator from the exterior of the refrigerator. When the door 20 is pulled to separate the refrigerator door 20 from the refrigerator main body 10, a tensile load is applied such that the door liner 21 of the door 20 pulls the coupling portion 30c of the gasket 30. Due to the tensile load transmitted to the coupling portion 30c, the connection portion 30b integrally formed with the coupling portion 30c is pulled, and the contact portion 30a in which the magnet 33 is inserted is also pulled. As a result, the contact portion 30a attached to the front surface of the refrigerator main body 10 by magnetic force is separated from the outer case 11 of the refrigerator main body 10, thereby opening the refrigerator main body 10.

As described above, the gasket 30 used for the refrigerator door 20 requires various conditions due to the characteristics of the refrigerator, and among theses, the most important condition is, as described above, a thermal insulation function that maintains an airtight state between the door 20 and the main body 10 of the refrigerator, thereby preventing leakage of cold air to the outside and blocking heat transfer from the outside of the refrigerator to the inside.

The solid-line arrows illustrated in FIG. 1 indicate a path through which heat from a hot line 13 is conducted through an inner case 12, and the dashed-line arrows illustrated in FIG. 1 indicate a path along which cold air is lost between the inner case 12 and the door liner 21. A body 31 of a gasket 30 used in conventional refrigerators has a thermal conductivity exceeding 0.2 W/m·K, and thus heat transfer from the outside to the inside occurs as indicated by the solid-line arrows in FIG. 1, or cold air inside is lost as indicated by the dashed-line arrows in FIG. 1, resulting in energy loss in the refrigerator.

Accordingly, the disclosure relates to a gasket for a refrigerator door with improved thermal insulation to reduce power consumption of a refrigerator, and specifically to a gasket for a refrigerator door in which the thermal insulation is improved by controlling a composition of a gasket body and a composition of a magnet inserted into a gasket.

A gasket for a refrigerator door according to an embodiment of the disclosure includes, in weight %, a thermoplastic resin in an amount of 30% to 60%; a low molecular weight plasticizer having a weight average molecular weight of less than 500 in an amount of 15% to 30%; a high molecular weight plasticizer having a weight average molecular weight of 500 or more in an amount of 5% to 20%; and a filler in an amount of 1% to 30%.

Hereinafter, reasons for limiting the composition of the gasket for the refrigerator door are described in detail.

### Thermoplastic Resin: 30 to 60 Weight %

The gasket for the refrigerator door is continuously subjected to stress while repeatedly bending and unbending during opening and closing of the door. Accordingly, for durability, it is desirable for the body of the gasket for the refrigerator door to ensure sufficient strength and ductility. In addition, in order to form air pockets for absorbing shock, provide a structure in which a magnet may be inserted, and ensure smooth opening and closing operation of the door, it is desirable for the body of the gasket for the refrigerator door to ensure sufficient profile extrusion properties so as to be manufactured in a complex shape.

According to the disclosure, a thermoplastic resin is a soft material suitable for profile extrusion and is actively added to ensure physical properties such as tensile strength, elongation, and hardness of the gasket body. When the content of the added thermoplastic resin is less than 30 weight %, profile extrusion is difficult and durability is insufficient. On the other hand, when the content exceeds 60 weight %, thermal insulation performance is degraded. Accordingly, in the disclosure, the thermoplastic resin may be added in an amount of 30 to 60 weight %.

According to the disclosure, the thermoplastic resin is not particularly limited in its components as long as the gasket body has sufficient moldability, durability, and surface tackiness.

The thermoplastic resin may include one or more selected from the group consisting of polyvinyl chloride (PVC), polyethylene (PE), polypropylene (PP), thermoplastic elastomer (TPE), thermoplastic vulcanizate (TPV), and thermoplastic polyolefin (TPO).

### Plasticizer: 20 to 40 Weight %

According to the disclosure, the plasticizer causes plastic flow of the thermoplastic resin of the above-described polymer, thereby facilitating processing such as extrusion and compression molding for manufacturing the gasket. In addition, since the gasket composition according to the present disclosure includes a filler to be described below and thus exhibits increased hardness, the plasticizer is actively added to impart processability.

When the content of the added plasticizer is less than 20 weight %, ductility suitable for profile extrusion may not be ensured. On the other hand, when the content exceeds 40 weight %, thermal conductivity performance is degraded. Accordingly, in the disclosure, the plasticizer may be added in an amount of 20 to 40 weight %.

Meanwhile, since plasticizers generally have high volatility and are prone to decompose and migrate to adjacent materials in high-temperature and high-humidity environments, it may be considered to limit the type of the plasticizer to increase mechanical properties and improve thermal insulation performance.

The plasticizer according to the disclosure includes 15 to 30 weight % of a low molecular weight plasticizer having a weight-average molecular weight of less than 500, and 5 to 10 weight % of a high molecular weight plasticizer having a weight-average molecular weight of 500 or more.

Typical plasticizers having a molecular weight of 500 or less include DOP, which has a molecular weight of 391 and DINP, which has a molecular weight of 419. Such low-molecular weight plasticizers may migrate organic substances to an adjacent material, such as an inner case of the refrigerator, under high-temperature and high-humidity conditions, thereby causing damage to the appearance. To address this issue, use of a high-molecular weight plasticizers is required. However, when only a high-molecular weight plasticizer is used, manufacturing becomes difficult due to an increase in viscosity, and thus it is required to determine the optimal balance. Through this, intermolecular bonding is increased, and mechanical properties may also be improved. Accordingly, the high-molecular weight plasticizer may be added in an amount of 5 to 10 weight %.

The low-molecular weight plasticizer according to the disclosure may include one or more selected from dioctyl phthalate (DOP), dioctyl adipate (DOA), diisodecyl phthalate (DIDP), or trioctyl trimellitate (TOTM).

The high-molecular weight plasticizer according to the disclosure may include one or more selected from epoxidized soybean oil (ESBO) or epoxidized linseed oil (ELO).

### Filler: 1 to 30 Weight %

According to the disclosure, the filler is an important component that improves thermal insulation by lowering the thermal conductivity of the gasket body for the refrigerator door. The filler has a thermal conductivity of 0.0001 to 0.2 W/m·K, which is lower than that of the above-described plasticizer and thermoplastic resin, thereby improving thermal insulation of the gasket body.

According to the disclosure, the filler is added in an amount of 1 weight % or more for the purpose of lowering thermal conductivity. However, when the filler is excessively added, mechanical properties such as tensile strength, elongation, and hardness of the gasket body may be degraded, resulting in reduced durability. Considering this, in the disclosure, it is preferable that an upper limit of the filler added to the gasket body is limited to 30 weight %.

The filler according to the disclosure is provided as one or more hollow particles accounting for 50% or more by volume thereof and having a diameter of 1 to 100 μm, or a porous material, and the thermal conductivity of the filler may be 0.0001 to 0.2 W/m·K. Hereinafter, embodiments of the filler will be described.

The filler according to an embodiment of the disclosure may be provided as one or more hollow particles accounting for 50% or more by volume thereof of the filler and having a diameter of 1 to 100 μm. In this specification, the term “hollow particle” refers to a particle having an outer shell that forms a closed pore therein. The outer shell of the hollow particle may be composed of silica, but is not limited thereto.

According to the disclosure, in order to increase the thermal insulation of the hollow particles, a thermal insulating material having low thermal conductivity may be filled in the pores of the hollow particles. According to one example, a thermal insulating material having a thermal conductivity of 0.03 W/m·K or less may be filled in the pores. For the purpose of sufficiently lowering thermal conductivity, the thermal insulating material may be filled in the pores at a filling rate of 10 to 60%. In this specification, the term “filling rate” refers to a percentage of a volume of the thermal insulating material filled in the pores relative to a total volume of the pores. Since a higher filling rate is advantageous in terms of thermal insulation, a lower limit of the filling rate may preferably be 20%, more preferably 30%. However, since a high filling rate may cause degradation of mechanical properties such as tensile strength, an upper limit of the filling rate may preferably be 50%.

In addition, in order to increase the thermal insulation of the hollow particles, the pores of the hollow particles may be in a vacuum state. In the disclosure, the term “vacuum state” refers to a complete vacuum state or a partial vacuum state, and it is preferable to increase the degree of vacuum in order to lower thermal conductivity. Accordingly, the partial vacuum state is preferably within a high vacuum range (10⁻⁴ Torr~10⁻⁷ Torr) to an ultra-high vacuum range (10⁻¹⁰ Torr or less).

Meanwhile, when the above-described thermal insulating material is in a liquid or solid state, a region other than a region filled with the thermal insulating material may be processed into a vacuum state using a vacuum pump or the like. In this case, there is an advantage in that thermal conductivity may be lowered while reducing manufacturing costs compared to increasing the degree of vacuum.

The filler according to another embodiment of the disclosure may be provided as a porous material. In this specification, the term “porous material” refers to a material including one or more closed pores. Examples of the porous material include porous ceramic materials, but are not limited thereto.

According to the disclosure, in order to increase the thermal insulation of the porous material, a thermal insulating material having low thermal conductivity may be filled in the pores of the porous material. According to one example, a thermal insulating material having a thermal conductivity of 0.03 W/m·K or less may be filled in the pores. For the purpose of sufficiently lowering thermal conductivity, the thermal insulating material may be filled in the pores at a filling rate of 10 to 60%. Since a higher filling rate is advantageous in terms of thermal insulation, a lower limit of the filling rate may preferably be 20%, more preferably 30%. However, since a high filling rate may cause degradation of mechanical properties such as tensile strength, an upper limit of the filling rate may preferably be 50%.

In addition, in order to increase the thermal insulation of the porous material, the pores of the porous material may be in a vacuum state. In the disclosure, the term “vacuum state” refers to a complete vacuum state or a partial vacuum state, and it is preferable to increase the degree of vacuum in order to lower thermal conductivity. Accordingly, the partial vacuum state is preferably within a high vacuum range (10⁻⁴ Torr~10⁻⁷ Torr) to an ultra-high vacuum range (10⁻¹⁰ Torr or less).

Meanwhile, when the above-described thermal insulating material is in a liquid or solid state, a region other than a region filled with the thermal insulating material may be processed into a vacuum state using a vacuum pump or the like. In this case, there is an advantage in that thermal conductivity may be lowered while reducing manufacturing costs compared to increasing the degree of vacuum.

According to the disclosure, the porous material preferably includes a large amount of pores so as to allow the thermal insulating material to be filled therein or allow an interior thereof to be processed in a vacuum state. According to one example, a porosity of the porous material may be 10 to 60%. Here, the term “porosity” refers to a percentage of a volume occupied by pores in the porous material relative to a total volume of the porous material. Since a higher porosity is advantageous in terms of thermal insulation, a lower limit of the porosity may preferably be 20%, more preferably 30%. However, since a high porosity of the porous material may cause degradation of mechanical properties such as tensile strength, an upper limit of the porosity may preferably be 50%.

Meanwhile, as described above, the gasket may be manufactured by methods such as extrusion and compression molding, and for the filler to maintain a hollow state during the above-described manufacturing process, the filler is provided to have a compressive strength of 500 to 20,000 PSI, more preferably 3,000 to 6,000 PSI.

Although two embodiments of the filler according to the present disclosure have been described above, the technical concept of the present disclosure is not limited thereto. Various materials having closed spaces in which an insulating material may be filled and which may be processed into a vacuum state may be applied as the filler of the present disclosure.

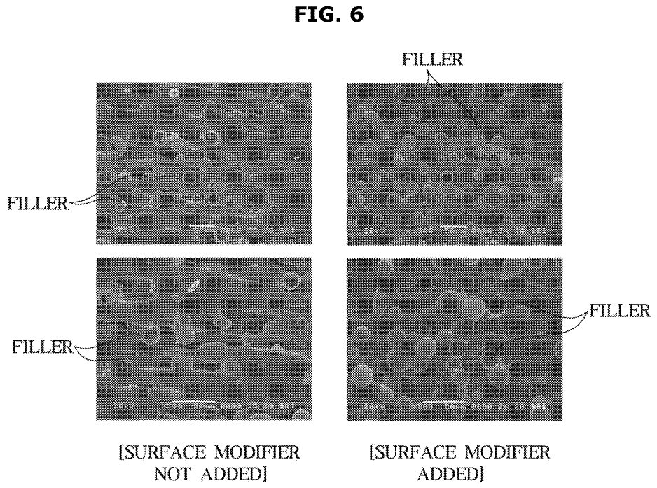

The filler may be present in the gasket composition as illustrated in FIG. 6. As described above, since the thermal conductivity of the filler may be lowered by filling pores of the filler with a thermal insulating material having low thermal conductivity or controlling the pores to be in a vacuum state, a higher volume fraction of the filler in the overall composition allows thermal conductivity of the material to be further reduced.

The gasket for the refrigerator door according to the disclosure may include other additives in addition to the above-described composition. Additives may include one or more of stabilizers, lubricants, reinforcing agents, antibacterial agents, and pigments. Hereinafter, each component will be described.

The stabilizer is added to improve the stability of the gaskets for the refrigerator door against heat, oxygen, ultraviolet rays, and the like. For example, the stabilizer may be heat-resistant stabilizers such as barium stearate, calcium stearate, epoxidized soybean oil; cold-resistant stabilizers such as butylene laurate complexes; weather-resistant stabilizers such as organic phosphite ester complexes, etc. The stabilizer may be included in an amount of 4 weight % or less.

The lubricant is added to improve the surface finish of molded extruded gaskets and facilitate dispersion of pigments. For example, the lubricant may be fatty alcohols, fatty acids, fatty acid amides, or the like.

The reinforcing agent is added to improve the mechanical strength, dimensional stability, heat deflection temperature, hardness, and other physical properties of the gaskets. For example, the reinforcing agents may be calcium carbonate (CaCO3)-based reinforcing agents, and the like.

The antibacterial agent may be added to prevent formation of mold or bacteria caused by migration of the plasticizers. The antibacterial agent may be included in an amount of 1 weight % or less.

The pigments may be added to obtain a desired color of the gasket body. For example, the pigments may be titanium oxide, carbon black, violet, and the like. The pigment may be included in an amount of 1 weight % or less.

The gasket for the refrigerator door according to the disclosure having the above-described composition includes the filler, thereby improving thermal insulation with a thermal conductivity of 0.2 W/m·K or less. Accordingly, cold air loss caused by the gasket may be reduced, thereby improving energy efficiency of the refrigerator.

A gasket for a refrigerator door according to another embodiment of the disclosure may include, as a thermoplastic resin, polyvinyl chloride in an amount of 15 to 30 weight % and thermoplastic elastomer in an amount of 15 to 30 weight %, and include a low molecular weight plasticizer having a weight average molecular weight of less than 500 in an amount of 15 to 30 weight %, a high molecular weight plasticizer having a weight average molecular weight of 500 or more in an amount of 5 to 10 weight %, and a filler in an amount of 1 to 30 weight %.

For a refrigerator gasket to have durability against repetitive physical external forces, it is required to recover stress in an elastic region. In this regard, polyvinyl chloride has relatively low relevant material properties. In addition, when a filler is included for thermal insulation, mechanical properties such as tensile strength, elongation, and hardness of the gasket is lowered as the filler content increases.

Therefore, in order to improve the above-described degradation in properties that may occur when using polyvinyl chloride as the thermoplastic resin and the degradation in properties due to an increase in filler content, the thermoplastic resin may include a mixture of polyvinyl chloride in an amount of 15 to 30 weight % and a thermoplastic elastomer in an amount of 15 to 30 weight %. When polyvinyl chloride and thermoplastic elastomer are mixed at such a ratio, the basic properties of the thermoplastic resin may be increased, thereby preventing the above-described degradation in gasket properties.

In addition to the above-described polyvinyl chloride, the thermoplastic resin may include polyethylene (PE), polypropylene (PP), or the like, and the elastomer may include one or more selected from the group consisting of styrene butadiene rubber, chloroprene rubber, silicone, thermoplastic polyurethane, thermoplastic vulcanizate, thermoplastic polyolefin, and thermoplastic styrene.

Description of the plasticizers, fillers, and other additives are the same as described above and thus are omitted.

The gasket body for the refrigerator door according to the disclosure having the above-described composition includes the thermoplastic resin mixed with an elastomer, thereby improving tensile strength and also exhibiting improved thermal insulation with a thermal conductivity of 0.2 W/m·K or less. Accordingly, cold air loss caused by the gasket may be reduced, thereby improving energy efficiency of the refrigerator.

A gasket for a refrigerator door according to another embodiment of the disclosure may include a surface modifier in an amount of 0.5 to 5 weight %, a thermoplastic resin in an amount of 30 to 60 weight %, a low molecular weight plasticizer having a weight average molecular weight of less than 500 in an amount of 15 to 30 weight %, a high molecular weight plasticizer having a weight average molecular weight of 500 or more in an amount of 5 to 10 weight %, and a filler in an amount of 1 to 30 weight %.

As described above, a filler may be added to improve thermal insulation, but when the amount of the added filler increases, mechanical properties such as tensile strength, elongation, and hardness of the gasket body may be degraded, resulting in reduced durability. That is, when the amount of the added filler increases, an interface is formed between an organic thermoplastic resin and an inorganic filler, and an interface separation may increase degradation of mechanical properties such as tensile strength.

Therefore, to address this issue, the gasket includes a surface modifier to improve adhesion between the organic thermoplastic resin and the inorganic filler, thereby improving mechanical properties such as tensile strength. The surface modifier may include one or more of a silane coupling agent, a titanate coupling agent, or a zirconate coupling agent.

For example, in the case of a silane coupling agents, an alkoxysilyl group (Si—OR) that improves degradation due to interface separation is hydrolyzed by water or moisture to form a silanol group (Si—OH). The silanol group bonds to an inorganic surface through a condensation reaction to increase bonding strength, and another reactive group of the silane coupling agent that chemically bonds with organic material bond or is compatible with organic material, consequently chemically bonding the inorganic material and the organic material. Through this, the surface modifier increases the bonding strength between the organic thermoplastic resin and the inorganic filler, thereby improving mechanical properties such as tensile strength even when the amount of added filler increases.

The surface modifier according to the disclosure may be added in an amount of 0.5 weight % or more to prevent degradation in mechanical properties due to addition of the filler. When the amount added is excessively low, the effect of adding the surface modifier does not appear, and thus a lower limit of the surface modifier is set to 0.5 weight %. However, when the surface modifier is excessively added, problems such as cost increase, over-treatment, adhesion between treated materials, and difficulty in drying may occur. Therefore, it is preferable that an upper limit of the surface modifier is limited to 5 weight %.

Such a surface modifier may be added by treating the inorganic surface directly or by adding simultaneously during mixing. Considering the manufacturing process and workability, simultaneous addition and mixing during the mixing process is preferable.

However, since such a surface modifier has a high molecular weight, when added during mixing, the dispersibility of the surface modifier may decrease. To prevent such dispersibility decrease and ensure uniform dispersion, an increased addition amount or an increased mixing time may be required. To prevent dispersibility decrease of such surface modifiers and ensure efficient dispersion of surface modifiers, a molecular weight (g/mol) of the surface modifier may be limited to 100 to 500 g/mol.

The gasket body for the refrigerator door according to the disclosure having the above-described composition includes the surface modifier, and although depending on the filler content, exhibits an average tensile strength improvement of approximately 100% compared to a case without the surface modifier, and also exhibits improved thermal insulation such that thermal conductivity is 0.2 W/m·K or less. Accordingly, cold air loss caused by the gasket may be reduced, thereby improving energy efficiency of the refrigerator.

A gasket 30 for a refrigerator door according to another embodiment of the disclosure includes: a body 31 disposed between a refrigerator main body 10 and a refrigerator door 20; and
a magnet 33 inserted into the body 31 and provided to be attachable to and detachable from the refrigerator main body 10;
wherein the body 31 includes, in weight %, a thermoplastic resin in an amount of 30% to 60%; a low molecular weight plasticizer having a weight average molecular weight of less than 500 in an amount of 15% to 30%; a high molecular weight plasticizer having a weight average molecular weight of 500 or more in an amount of 5% to 20%; and a filler in an amount of 1% to 30%, and
the magnet 33 includes, in weight %, ferrite powder in an amount of 40% to 89.5%, a thermoplastic resin in an amount of 10% to 40%, and a filler in an amount of 0.5% to 20%.

A form in which the magnet is inserted is not particularly limited, as long as the magnet is inserted into the gasket body such that the magnet is detachably attachable to an outer case of the refrigerator main body formed of a magnetic material by magnetic force of the magnet. According to an example, the magnet may be inserted such that the body surrounds an entire surface of the magnet, or the magnet may be inserted such that one surface of the magnet is exposed toward the refrigerator main body and the body surrounds remaining surfaces of the magnet except for the exposed surface.

Hereinafter, reasons for limiting the composition of the magnet for the refrigerator door gasket are described in detail.

### Ferrite Powder: 40 to 89.5 Weight %

The ferrite powder is a key component that imparts magnetism to the magnet. Considering this, in the disclosure, ferrite powder is actively added, and a lower limit of addition for providing the magnet with magnetism may be 40 weight %. Although the composition of the ferrite powder may be variously adjusted in consideration of magnetic strength, an upper limit of the ferrite powder may be 89.5 wt % in view of the filler added to improve the above-described thermal insulation and the content of the thermoplastic resin components added considering impact characteristics, and the like, an upper limit of the ferrite powder addition may be 89.5 weight %.

According to one example of the disclosure, the ferrite powder may include one or more of Sr-ferrite oxide powder, Ba-ferrite oxide powder, or rare earth powder.

### Thermoplastic Resin: 10 to 40 Weight %

The thermoplastic resin is added for sufficient durability such as impact characteristics of the magnet. Considering this, in the disclosure, the thermoplastic resin is added in an amount of 10 weight % or more. However, when the thermoplastic resin exceeds 40 weight %, thermal insulation performance may be degraded. Accordingly, in the disclosure, the thermoplastic resin may be added in an amount of 10 to 40 weight %.

According to one example of the disclosure, the thermoplastic resin may include one or more selected from the group consisting of polyethylene (PE), polypropylene (PP), polyvinyl chloride (PVC), acrylonitrile-butadiene-styrene (ABS), polyamide (PA), and chlorinated polyethylene (CPE).

### Filler: 0.5 to 20 Weight %

In the disclosure, the filler is an important component that improves thermal insulation by lowering the thermal conductivity of the magnet for the refrigerator door. The filler has a thermal conductivity of 0.0001 to 0.2 W/m·K, which is lower than that of the ferrite powder and the thermoplastic resin described above, thereby improving the thermal insulation of the magnet.

According to the disclosure, the filler is added in an amount of 0.5 weight % or more for the purpose of lowering thermal conductivity. However, when the filler is excessively added, mechanical properties such as impact characteristics of the magnet may be degraded, resulting in reduced durability, and sufficient magnetism may not be ensured. Considering this, in the disclosure, an upper limit of the filler added to the magnet is preferably limited to 20 weight %.

Examples of the filler added to the magnet are the same as those described above, and thus a detailed description thereof is omitted for convenience.

According to one example of the disclosure, the filler may be provided as one or more hollow particles having a diameter of 1 to 100 μm or a porous material.

According to the disclosure, in order to increase the thermal insulation performance of the filler, pores of the hollow particles or pores of the porous material may be filled with a thermal insulating material having a thermal conductivity of 0.03 W/m·K or less. For the purpose of sufficiently lowering the thermal conductivity, the thermal insulating material may be filled in the pores at a filling rate of 10 to 60%. Since a higher filling rate is advantageous in terms of thermal insulation, a lower limit of the filling rate may preferably be 20%, more preferably 30%. However, since a high filling rate may cause degradation of mechanical properties such as tensile strength, an upper limit of the filling rate may preferably be 50%.

In addition, in order to increase the thermal insulation of the filler, the pores of the hollow particles or the pores of porous material may be in a vacuum state. When the thermal insulating material is in a liquid or solid state, a region other than a region filled with the thermal insulating material may be processed into a vacuum state using a vacuum pump or the like. In this case, there is an advantage in that thermal conductivity may be lowered while reducing manufacturing costs compared to increasing the degree of vacuum.

According to the disclosure, the porous material preferably includes a large amount of pores so as to allow the thermal insulating material to be filled therein or allow an interior thereof to be processed in a vacuum state. According to one example, a porosity of the porous material may be 10 to 60%. Since a higher porosity is advantageous in terms of thermal insulation, a lower limit of the porosity may preferably be 20%, more preferably 30%. However, since a high porosity of the porous material may cause degradation of mechanical properties such as tensile strength, an upper limit of the porosity may preferably be 50%.

The magnet for the refrigerator door according to the disclosure may further include a binder and a pigment in addition to the above-described composition.

The binder is added to increase extrusion moldability when the above-described composition is mixed and then extruded. For example, the binder may be chlorinated rubber, or the like.

The pigment is added to obtain a desired color of the magnet. For example, the pigment may be titanium oxide, carbon black, violet, or the like.

The magnet for the refrigerator door according to the disclosure having the above-described composition can have improved thermal insulation performance with a thermal conductivity of 1 W/m·K or less. Accordingly, cold air loss caused by the gasket may be reduced, thereby improving energy efficiency.

In addition, the magnet of the refrigerator door gasket according to the disclosure can exhibit excellent thermal insulation performance while ensuring a magnetic force of 70 g/50 mm or more, thereby providing a magnetic force suitable for use as a gasket for a refrigerator door gasket.

The disclosure may provide a refrigerator including the above-described gasket for the refrigerator door. According to the disclosure, a refrigerator that includes a main body forming a storage compartment, a door provided to open and close the storage compartment, and the gasket of the above-described embodiment disposed between the main body and the door may be provided.

Hereinafter, the disclosure will be described in further detail with reference to examples. It should be understood, however, that the following examples are provided solely for illustrative purposes and are not intended to limit the scope of the disclosure. The scope of the disclosure is defined by the appended claims and matters reasonably inferred therefrom.

### EXAMPLES

Components of a body composition for a refrigerator door gasket having the composition shown in Table 1 below were mixed, compounded, extruded, and then molded to manufacture a body of a gasket for a refrigerator door. In this case, the extrusion molding temperature was 140 to 200° C. The thermal conductivity, tensile strength, elongation, and hardness of the manufactured body were measured and shown in Table 1.

TABLE 1

| | | | | | | | | Mechanical | | |
|---|---|---|---|---|---|---|---|---|---|---|
| | Thermo- | | | | | | | properties | | |
| | plastic | | | | | | Thermal | Tensile | | |
| | resin | Plasticizer (wt %) | | | Filler | Additive | conductivity | strength | Elongation | Hardness |
| Examples | (wt %) | Total | HMW | LMW | (wt %) | (wt %) | (W/m · K) | (kgf/mm²) | (%) | (Hs) |
| Comparative | 60 | 35 | 0.0 | 35.0 | 0 | 5.0 | 0.24 | 1.5 | 380 | 64 |
| example 1 | | | | | | | | | | |
| Invention | 57 | 35 | 3.0 | 32.0 | 3 | 5.0 | 0.19 | 1.3 | 370 | 65 |
| example 1 | | | | | | | | | | |
| Invention | 52.5 | 35 | 8.0 | 27.0 | 7.5 | 5.0 | 0.16 | 1.1 | 360 | 67 |
| example 2 | | | | | | | | | | |
| Invention | 45 | 35 | 11.0 | 24.0 | 15 | 5.0 | 0.14 | 0.8 | 250 | 68 |
| example 3 | | | | | | | | | | |
| Invention | 42.5 | 35 | 15.0 | 20.0 | 17.5 | 5.0 | 0.12 | 0.7 | 210 | 68 |
| example 4 | | | | | | | | | | |
| Invention | 30 | 35 | 20.0 | 15.0 | 30 | 5.0 | 0.10 | 0.5 | 150 | 70 |
| example 5 | | | | | | | | | | |

Referring to Table 1, it can be confirmed that, when the composition range of the gasket body for the refrigerator door defined in the disclosure is satisfied, thermal insulation performance is improved by satisfying a thermal conductivity of 0.2 W/m·K or less. In addition, it can be confirmed that, while exhibiting excellent thermal insulation, the gasket body has mechanical properties suitable for a gasket body for a refrigerator door by satisfying a tensile strength of 0.5 kgf/mm² or more, an elongation of 15% or more, and a hardness of 60 to 70 Hs.

Components of a magnet composition for a refrigerator door gasket having the composition shown in Table 2 below were mixed, compounded, extruded, and then molded to manufacture a magnet for a gasket for a refrigerator door. The thermal conductivity and magnetic force of the manufactured magnet were measured and shown in Table 2.

TABLE 2

| | Ferrite | Thermo- | | Thermal | Magnetic |
|---|---|---|---|---|---|
| | Powder | plastic | Filler | Conductivity | Force |
| Examples | (wt %) | Resin (wt %) | (wt %) | (W/m · K) | (g/50 mm) |
| Invention | 89.5 | 10 | 0.5 | 1 | 100 |
| example 6 | | | | | |
| Invention | 87.5 | 10 | 2.5 | 0.95 | 85 |
| example 7 | | | | | |
| Invention | 85 | 10 | 5 | 0.9 | 80 |
| example 8 | | | | | |
| Invention | 82.5 | 10 | 7.5 | 0.85 | 75 |
| example 9 | | | | | |
| Invention | 80 | 10 | 10 | 0.8 | 70 |
| example 10 | | | | | |

Referring to Table 2, it can be confirmed that, when the composition range of the magnet for the refrigerator door gasket defined in the disclosure, the thermal insulation performance is improved by satisfying a thermal conductivity of 1 W/m·K or less. In addition, it can be confirmed that, while exhibiting excellent thermal insulation, the magnet has a magnetic force suitable for a magnet for a refrigerator door gasket by ensuring a magnetic force of 70 g/50 mm or more.

In Table 3 below, improvement in migration resistance of the gasket according to use of a high-molecular weight plasticizer was evaluated.

The migration resistance was evaluated according to the following methods, and migration resistance according to changes in the content of the high-molecular weight plasticizer can determined.
1) Test method: Two materials were brought into contact and left in a constant temperature and humidity chamber at 60° C. and 95% relative humidity for 6 hours.
(2) Evaluation method: Visual evaluation (performed using the following two-level inspection):

Final non-migration score: the number of streaks×a weighting factor
Level 1 inspection: the degree observable by the naked eye without light reflection (a weighting factor: 1.0)
Level 2 inspection: the degree observable by the naked eye through light reflection (a weighting factor: 0.5).

TABLE 3

| | High-molecular weight plasticizer content (wt %) | | | | | | | |
|---|---|---|---|---|---|---|---|---|
| | 0% | 2% | 5% | 6% | 8% | 10% | 15% | 20% |
| Level 1 | 4 × 1 | 4 × 1 | 0 | 0 | 0 | 0 | 0 | 0 |
| Level 2 | 8 × 0.5 | 5 × 0.5 | 7 × 0.5 | 6 × 0.5 | 5 × 0.5 | 4 × 0.5 | 2 × 0.5 | 1 × 0.5 |
| Total score | 8 | 6.5 | 3.5 | 3.0 | 2.5 | 2.0 | 1.0 | 0.5 |

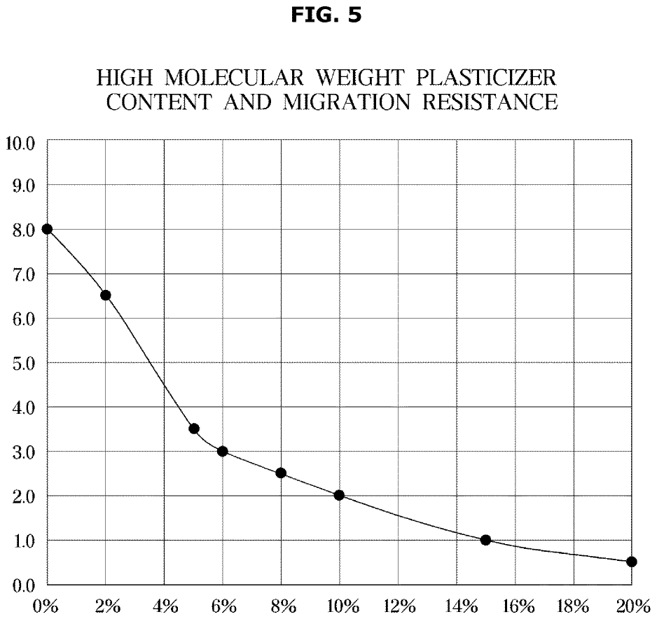

Referring to Table 3 and FIG. 5, it can be confirmed that as the content of the high molecular weight plasticizer is included up to 20 weight %, the evaluation result score decreases, which indicates improved migration resistance.

Table 4 below shows examples in which an elastomer is blended with a thermoplastic resin.

Components of a body composition for a refrigerator door gasket having the composition shown in Table 4 were mixed, compounded, extruded, and then molded to manufacture a body of for a refrigerator door gasket. In this case, the extrusion molding temperature was 140 to 200° C. The thermal conductivity and tensile strength of the manufactured body were measured and shown in Table 4.

TABLE 4

| | Thermo- | | | | | | | | |
|---|---|---|---|---|---|---|---|---|---|
| | plastic | | | | | | | Thermal | Tensile |
| | resin | Elastomer | Plasticizer (wt %) | | | Filler | Additive | conductivity | strength |
| Examples | (wt %) | (wt %) | Total | HMW | LMW | (wt %) | (wt %) | (W/m · K) | (kgf/mm² |
| Invention | 10.0 | 42.5 | 35 | 8.0 | 27.0 | 7.5 | 5.0 | 0.16 | 1.5 |
| example 11 | | | | | | | | | |
| Invention | 30.0 | 22.5 | 35 | 8.0 | 27.0 | 7.5 | 5.0 | 0.16 | 1.2 |
| example 12 | | | | | | | | | |

Inventive Example 11 is an example in which, compared with Inventive Example 2, the composition is the same except for the thermoplastic resin, and an elastomer is added in an amount of 42.5 wt %. Inventive Example 12 is an example in which, compared with Inventive Example 2, an elastomer is added in an amount of 22.5 wt %. It can be confirmed that tensile strength is increased due to the addition of the elastomer.

Table 5 below shows examples in which a surface modifier is further added.

Components of a body composition for a refrigerator door gasket having the composition shown in Table 5 were mixed, compounded, extruded, and then molded to manufacture a body for a refrigerator door gasket. In this case, the extrusion molding temperature was 140 to 200° C. The thermal conductivity and tensile strength of the manufactured body were measured and shown in Table 5.

TABLE 5

| | Thermo- | | | | | | | | |
|---|---|---|---|---|---|---|---|---|---|
| | plastic | | | | | | Surface | Thermal | Tensile |
| | resin | Plasticizer (wt %) | | | Filler | Additive | modifier | conductivity | strength |
| Examples | (wt %) | Total | HMW | LMW | (wt %) | (wt %) | (wt %) | (W/m · K) | (kgf/mm² |
| Invention | 57 | 35 | 3.0 | 32.0 | 3 | 4.0 | 1.0 | 0.19 | 1.4 |
| example | | | | | | | | | |
| 13 | | | | | | | | | |
| Invention | 52.5 | 35 | 8.0 | 27.0 | 7.5 | 4.0 | 1.0 | 0.16 | 1.2 |
| example | | | | | | | | | |
| 14 | | | | | | | | | |
| Invention | 45 | 35 | 11.0 | 24.0 | 15 | 4.0 | 1.0 | 0.14 | 0.9 |
| example | | | | | | | | | |
| 15 | | | | | | | | | |
| Invention | 42.5 | 35 | 15.0 | 20.0 | 17.5 | 4.0 | 1.0 | 0.12 | 0.8 |
| example | | | | | | | | | |
| 16 | | | | | | | | | |
| Invention | 30 | 35 | 20.0 | 15.0 | 30 | 4.0 | 1.0 | 0.10 | 0.6 |
| example | | | | | | | | | |
| 17 | | | | | | | | | |

Inventive Examples 13 to 17 are examples in which, compared with Inventive Examples 1 to 5, respectively, the compositions are the same except for the content of additives, and a surface modifier is added in an amount of 1.0 wt %. It can be confirmed that tensile strength is increased by inclusion of the surface modifier.

As described above, the disclosed embodiments have been described with reference to the attached drawings and tables. Those with ordinary knowledge in the technical field to which the disclosure belongs will understand that the disclosure may be implemented in forms different from the disclosed embodiments without changing the technical concept or essential features of the disclosure. The disclosed embodiments are illustrative and should not be interpreted as limiting.

According to one aspect of the disclosure, it is possible to provide a gasket for a refrigerator door including, in weight %, a thermoplastic resin in an amount of 30% to 60%; a low molecular weight plasticizer having a weight-average molecular weight of less than 500 in an amount of 15% to 30%; a high molecular weight plasticizer having a weight-average molecular weight of 500 or more in an amount of 5% to 20%; and a filler in an amount of 1% to 30%.

According to one aspect of the disclosure, it is possible to provide the gasket, wherein the filler is provided as one or more hollow particles accounting for 50% or more by volume thereof and having a diameter of 1 μm to 100 μm, or a porous material, wherein the filler has a thermal conductivity of 0.0001 W/m·K to 0.2 W/m·K.

According to one aspect of the disclosure, it is possible to provide the gasket, wherein pores of the hollow particles or pores of the porous material are filled with a thermal insulating material having a thermal conductivity of 0.03 W/m·K or less.

According to one aspect of the disclosure, it is possible to provide the gasket, wherein the filler has a compressive strength of 500 PSI to 20,000 PSI.

According to one aspect of the disclosure, it is possible to provide the gasket, wherein the thermoplastic resin includes one or more selected from the group consisting of polyvinyl chloride, polyethylene, polypropylene, thermoplastic elastomer, thermoplastic vulcanizate, and thermoplastic polyolefin.

According to one aspect of the disclosure, it is possible to provide the gasket, wherein the thermoplastic resin includes polyvinyl chloride in an amount of 15% to 30%, and thermoplastic elastomer in an amount of 15% to 30%.

According to one aspect of the disclosure, it is possible to provide the gasket, wherein the thermoplastic elastomer includes one or more selected from the group consisting of styrene butadiene rubber, chloroprene rubber, silicone, thermoplastic polyurethane, thermoplastic vulcanizate, thermoplastic polyolefin, and thermoplastic styrene.

According to one aspect of the disclosure, it is possible to provide the gasket, further including a surface modifier in an amount of 0.5% to 5%.

According to one aspect of the disclosure, it is possible to provide the gasket, wherein the surface modifier has a molecular weight of 100 g/mol to 1000 g/mol.

According to one aspect of the disclosure, it is possible to provide the gasket, wherein the low molecular weight plasticizer includes one or more selected from the group consisting of dioctyl phthalate, dioctyl adipate, diisodecyl phthalate, and trioctyl trimellitate.

According to one aspect of the disclosure, it is possible to provide the gasket, wherein the high molecular weight plasticizer includes one or more selected from the group consisting of epoxidized soy bean oil (ESBO) and epoxidized linseed oil (ELO).

According to one aspect of the disclosure, it is possible to provide a gasket for a refrigerator door including: a body disposed between a refrigerator main body and a refrigerator door; and
a magnet inserted into the body and configured to be attachable to and detachable from the refrigerator main body,
wherein the body includes, in weight %, a thermoplastic resin in an amount of 30% to 60%; a low molecular weight plasticizer having a weight-average molecular weight of less than 500 in an amount of 15% to 30%; a high molecular weight plasticizer having a weight-average molecular weight of 500 or more in an amount of 5% to 20%; and a filler in an amount of 1% to 30%, and
the magnet include, in weight %, ferrite powder in an amount of 40% to 89.5%, a thermoplastic resin in an amount of 10% to 40%, and a filler in an amount of 0.5% to 20%.

According to one aspect of the disclosure, it is possible to provide the gasket, wherein the fillers are each provided as one or more hollow particles accounting for 50% or more by volume thereof and having a diameter of 1 μm to 100 μm, or a porous material, wherein each of the fillers has a thermal conductivity of 0.0001 W/m·K to 0.2 W/m·K.

According to one aspect of the disclosure, it is possible to provide the gasket, wherein pores of the hollow particles or pores of the porous material are filled with a thermal insulating material having a thermal conductivity of 0.03 W/m·K or less.

According to one aspect of the disclosure, it is possible to provide the gasket, wherein each of the fillers has a compressive strength of 500 PSI to 20,000 PSI.

According to one aspect of the disclosure, it is possible to provide the gasket, wherein the thermoplastic resin includes polyvinyl chloride in an amount of 15 to 30 weight %, and thermoplastic elastomer in an amount of 15 to 30 weight %.

According to one aspect of the disclosure, it is possible to provide the gasket, wherein the thermoplastic elastomer includes one or more selected from the group consisting of styrene butadiene rubber, chloroprene rubber, silicone, thermoplastic polyurethane, thermoplastic vulcanizate, thermoplastic polyolefin, and thermoplastic styrene.

According to one aspect of the disclosure, it is possible to provide the gasket, further including a surface modifier in an amount of 0.5% to 5%, wherein the surface modifier has a molecular weight of 100 g/mol to 1000 g/mol.

According to one aspect of the disclosure, it is possible to provide the gasket, wherein the low molecular weight plasticizer includes one or more selected from the group consisting of dioctyl phthalate, dioctyl adipate, diisodecyl phthalate, and trioctyl trimellitate.

According to one aspect of the disclosure, it is possible to provide the gasket, wherein the high molecular weight plasticizer includes one or more selected from the group consisting of epoxidized soy bean oil (ESBO) and epoxidized linseed oil (ELO).

As described above, a gasket for a refrigerator door according to one embodiment has been described.

1. A gasket for a refrigerator door, the gasket comprising:
a thermoplastic resin in an amount of 30% to 60% in weight %;
a low molecular weight plasticizer having a weight-average molecular weight of less than 500 in an amount of 15% to 30%;
a high molecular weight plasticizer having a weight-average molecular weight of 500 or more in an amount of 5% to 20%; and
a filler in an amount of 1% to 30% in weight %.

2. The gasket of claim 1, wherein the filler is provided as one or more hollow particles accounting for 50% or more by volume having a diameter of 1/m to 100 μm, or a porous material,
wherein the filler has a thermal conductivity of 0.0001 W/m·K to 0.2 W/m·K.

3. The gasket of claim 2, wherein pores of the one or more hollow particles or pores of the porous material are filled with a thermal insulating material having a thermal conductivity of 0.03 W/m·K or less.

4. The gasket of claim 1, wherein the filler has a compressive strength of 500 PSI to 20,000 PSI.

5. The gasket of claim 1, wherein the thermoplastic resin includes one or more selected from a group consisting of polyvinyl chloride, polyethylene, polypropylene, thermoplastic elastomer, thermoplastic vulcanizate, and thermoplastic polyolefin.

6. The gasket of claim 1, wherein the thermoplastic resin includes polyvinyl chloride in an amount of 15% to 30%, and thermoplastic elastomer in an amount of 15% to 30%.

7. The gasket of claim 6, wherein the thermoplastic elastomer includes one or more selected from a group consisting of styrene butadiene rubber, chloroprene rubber, silicone, thermoplastic polyurethane, thermoplastic vulcanizate, thermoplastic polyolefin, and thermoplastic styrene.

8. The gasket of claim 1, further comprising a surface modifier in an amount of 0.5% to 5%.

9. The gasket of claim 8, wherein the surface modifier has a molecular weight of 100 g/mol to 1000 g/mol.

10. The gasket of claim 1, wherein the low molecular weight plasticizer includes one or more selected from a group consisting of dioctyl phthalate, dioctyl adipate, diisodecyl phthalate, and trioctyl trimellitate.

11. The gasket of claim 1, wherein the high molecular weight plasticizer includes one or more selected from a group consisting of epoxidized soy bean oil (ESBO) and epoxidized linseed oil (ELO).

12. A gasket for a refrigerator door comprising:
a body disposed between a refrigerator main body and the refrigerator door; the body being configured to be attachable to and detachable from the refrigerator main body and configured to allow a magnet be inserted,
wherein the body includes:
a thermoplastic resin in an amount of 30% to 60% in weight %;
a low molecular weight plasticizer having a weight-average molecular weight of less than 500 in an amount of 15% to 30%;
a high molecular weight plasticizer having a weight-average molecular weight of 500 or more in an amount of 5% to 20%; and
a filler in an amount of 1% to 30% in weight %, and
the magnet comprises, in weight %, ferrite powder in an amount of 40% to 89.5%, a thermoplastic resin in an amount of 10% to 40%, and a filler in an amount of 0.5% to 20%.

13. The gasket of claim 12, wherein fillers are provided as one or more hollow particles accounting for 50% or more by volume having a diameter of 1 μm to 100 μm, or a porous material,
wherein the fillers have a thermal conductivity of 0.0001 W/m·K to 0.2 W/m·K.

14. The gasket of claim 13, wherein pores of the one or more hollow particles or pores of the porous material are filled with a thermal insulating material having a thermal conductivity of 0.03 W/m·K or less.

15. The gasket of claim 12, wherein fillers are provided to have a compressive strength of 500 PSI to 20,000 PSI.
